(19) United States
(12) Patent Application Publication
(10) Pub. No.: US 2026/0115767 A1
(43) Pub. Date: Apr. 30, 2026

(54) AUTOMATIC LOADING SYSTEM FOR SCREENING WOOD SHAVINGS AND INTELLIGENT SCREENING LINE

(71) Applicant: SHANDONG ACADEMY OF FORESTRY, Jinan (CN)

(72) Inventors: Changgui LI, Jinan (CN); Mu LI, Jinan (CN); Mingming HE, Jinan (CN); Laiyong GUO, Jinan (CN); Yahui WANG, Jinan (CN); Hongyi LI, Jinan (CN); Yuzhen MA, Jinan (CN); Jian GAO, Jinan (CN); Wanru DONG, Jinan (CN); Di CHEN, Jinan (CN); Anbao MA, Jinan (CN)

(21) Appl. No.: 19/357,362

(22) Filed: Oct. 14, 2025

(30) Foreign Application Priority Data
Oct. 24, 2024 (CN) 2024114938321

(51) Int. Cl. B07C 5/36; B07C 5/02; B07C 5/342

(52) U.S. Cl. CPC B07C 5/361; B07C 5/02; B07C 5/3425; B07C 2501/0063

(57) ABSTRACT

An automatic loading system for screening wood shavings, wherein discharging side of a material receiving and conveying mechanism is connected to feeding side of shaving arranging and conveying mechanisms, each shaving arranging and conveying mechanism includes first slide-down board, first conveying mechanism, second slide-down board, second conveying mechanism, third slide-down board, and third conveying mechanism sequentially disposed along wood shavings conveying direction, width of the first slide-down board is gradually reduced along wood shavings conveying direction to cause its discharging side's width corresponds to wood shavings'width, a baffle board is disposed above a feeding end of the second conveying mechanism with a set gap, and a feeding end of the third slide-down board locates below a discharging end of the second conveying mechanism at a first set distance, and a discharging end located above a feeding end of the third conveying mechanism at a second set distance.

### CROSS-REFERENCE TO RELATED APPLICATIONS

The present invention claims priority to Chinese Patent Application No. 202411493832.1, filed with the National Intellectual Property Administration, PRC on Oct. 24, 2024 and entitled “AUTOMATIC LOADING SYSTEM FOR SCREENING WOOD SHAVINGS AND INTELLIGENT SCREENING LINE”, which is incorporated herein by reference in its entirety and constitutes a part of the present invention, and is used for all purposes.

### TECHNICAL FIELD

The present invention relates to the field of wood shaving technologies, and specifically, to an automatic loading system for screening wood shavings and an intelligent screening line.

### BACKGROUND

Statement here only provides background technologies related to the present invention, and do not necessarily constitutes a related art.

A wood shaving board is made from wood shavings. Wood shaving detection is an important link in quality control of a wood shaving board production process. If wood shavings are unqualified, the grade of a wood shaving board product is reduced, the reject ratio is increased, and even a production accident occurs. Currently, there is no detection system for wood shavings. Manual detection is performed on wood shavings. The manual detection has high labor intensity and low detection efficiency, and cannot ensure detection quality. The current visual intelligent screening system can be applied to detecting and screening of wood shavings, to implement automatic and intelligent screening of the wood shavings, reduce labor intensity of working personnel, and improve detection efficiency, and can ensure detection quality. However, when the wood shavings are detected by using the visual intelligent screening system, the individual wood shavings need to be sequentially fed into the visual intelligent screening system at intervals of a particular distance for detection. Currently, when wood shavings are supplied, all the wood shavings are piled up together disorderedly. Therefore, how to automatically arrange the wood shavings piled up together disorderedly to cause the individual wood shavings to enter the visual intelligent screening system sequentially at intervals of a particular distance is an urgent problem to be resolved by a person skilled in the art.

### SUMMARY

In view of the shortcomings of the existing technology, an objective of the present invention is to provide an automatic loading system for screening wood shavings and an intelligent screening line, which can automatically separate wood shavings piled up disorderedly into a state in which the individual shavings are arranged sequentially at intervals of a particular distance, facilitating detection by using a visual intelligent screening system.

To achieve the above objective, the present invention is implemented by the following technical solutions:

According to a first aspect, an embodiment of the present invention provides an automatic loading system for screening wood shavings, including a material receiving and conveying mechanism, where a discharging side of the material receiving and conveying mechanism is connected to a feeding side of a plurality of shaving arranging and conveying mechanisms, each of the plurality of the shaving arranging and conveying mechanisms includes a first slide-down board, a first conveying mechanism, a second slide-down board, a second conveying mechanism, a third slide-down board, and a third conveying mechanism sequentially disposed along a conveying direction of wood shavings, a width of the first slide-down board is gradually reduced along the conveying direction of the wood shavings to cause the width of the first slide-down board on a discharging side of the first slide-down board to correspond to a width of the wood shavings, a baffle board is disposed above a feeding end of the second conveying mechanism, a set gap exists between a bottom end of the baffle board and a top surface of the second conveying mechanism to allow only a single wood shaving to pass through the gap between the baffle board and the second conveying mechanism, and the third slide-down board has a feeding end located below a discharging end of the second conveying mechanism at a first set distance, and a discharging end of the third slide-down board located above a feeding end of the third conveying mechanism at a second set distance.

Optionally, a fourth conveying mechanism is disposed in front of the first conveying mechanism at a third set distance, and a top surface of the fourth conveying mechanism is higher than a top surface of the first conveying mechanism by a fourth set distance to initially spread the stacked-up wood shavings.

Further, a tail end of the fourth conveying mechanism is connected to the material receiving and conveying mechanism.

Optionally, a first three-dimensional (3D) laser contour sensor and a blowing pump are sequentially disposed on a side of the second conveying mechanism downstream of the baffle board along the conveying direction of wood shavings, and the first 3D laser contour sensor is configured to detect the stacked-up wood shavings and the blowing pump is configured to blow the stacked-up wood shavings off.

Further, a fifth conveying mechanism is disposed on an opposite side of the blowing pump to receive the wood shavings blown off by the blowing pump, and a tail end of the fifth conveying mechanism is connected to the material receiving and conveying mechanism.

Optionally, the baffle board is connected to a first lifting mechanism to adjust a distance between the bottom end of the baffle board and the second conveying mechanism.

Optionally, the discharging end of the first slide-down board is hinged to a support board, another end of the first slide-down board is hinged to a first end of an angle adjustment cylinder, a second end of the angle adjustment cylinder is hinged to the support board, the support board is mounted on a first traveling vehicle through a second lifting mechanism, and correspondingly, the material receiving and conveying mechanism is mounted on a second traveling vehicle through a third lifting mechanism.

Optionally, a center position of the third slide-down board is connected to a rotation drive element to adjust an angle of the third slide-down board.

Optionally, the first slide-down board is connected to a vibration motor.

According to a second aspect, an embodiment of the present invention provides an intelligent screening line for wood shavings, including the automatic loading system for screening wood shavings according to the first aspect, where a discharging end of the third conveying mechanism corresponds to a feeding end of a visual intelligent screening system, the visual intelligent screening system includes a screening slide-down board, a transparent board is used as the screening slide-down board, and a second 3D laser contour sensor, a first sorting apparatus, a first color mark sensor group, a second sorting apparatus, a second color mark sensor group, and a third sorting apparatus are sequentially disposed along the conveying direction of the wood shavings, where the second 3D laser contour sensor and the first color mark sensor group are located above the screening slide-down board, and the second color mark sensor group is located below the screening slide-down board.

Optionally, the screening slide-down board is connected to an angle adjustment mechanism, and the second 3D laser contour sensor, the first sorting apparatus, the first color mark sensor group, the second sorting apparatus, the second color mark sensor group, and the third sorting apparatus are each connected to the screening slide-down board through a bracket.

Further, the second 3D laser contour sensor, the first color mark sensor group, and the second color mark sensor group are each connected to a bracket through a fourth lifting mechanism.

Optionally, robotic arms are used as the first sorting apparatus and the second sorting apparatus, and a vacuum chuck is disposed at a tail end of each of the robotic arms.

Beneficial effects of the present invention are as follows

1. According to the automatic loading system for screening wood shavings of the present invention, the width of the discharging end of the first slide-down board matches the width of wood shavings, so that the first slide-down board allows only a single wood shaving whose length direction is set along the conveying direction to pass through or a plurality of stacked-up wood shavings whose length direction is set along the conveying direction to pass through, thereby adjusting an orientation of the wood shavings, and directionally arranging the wood shavings. After the wood shavings enter the second conveying mechanism through the second slide-down board, the wood shavings are spread under the action of the baffle board, and lamination of the wood shavings is avoided. The feeding end of the third slide-down board is located below the discharging end of the second conveying mechanism at the set distance. Therefore, when the wood shavings fall into the third slide-down board, a particular distance is generated between adjacent wood shavings, and the wood shavings are arranged at intervals of the particular distance. After entering the third conveying mechanism, the wood shavings arranged at intervals of the particular distance can enter the visual intelligent screening system for detection through the third conveying mechanism. By using the loading system, a plurality of wood shavings is automatically arranged and conveyed sequentially at intervals of the particular distance, a requirement of performing detection and screening by using the visual intelligent screening system is satisfied, working efficiency and quality of detecting and screening wood shavings are improved, and labor intensity of working personnel is reduced.

2. According to the automatic loading system for screening wood shavings and the intelligent screening line of the present invention, the first slide-down board is connected to the angle adjustment cylinder, the second slide-down board is connected to the rotation drive element, the screening slide-down board is connected to the angle adjustment mechanism, and angles of the first slide-down board, the third slide-down board, and the screening slide-down board can be adjusted, satisfying a requirement for slide-down and conveying of different types of wood shavings, and improving applicability of the entire loading system and screening line.

### BRIEF DESCRIPTION OF THE DRAWINGS

The accompanying drawings of this specification that constitute a part of the present invention are used to provide a further understanding of the present invention. Exemplary embodiments of the present invention and descriptions thereof are used to explain the present invention, and do not constitute any inappropriate limitation to the present invention.

FIG. 1 is a schematic front view of an overall structure according to Embodiment 1 of the present invention;

FIG. 2 is a top view of connection between a material receiving and conveying mechanism and a first slide-down board when there are two shaving arranging and conveying mechanisms according to Embodiment 1 of the present invention;

FIG. 3 is a top view of connection between a material receiving and conveying mechanism and a first slide-down board when there are four shaving arranging and conveying mechanisms according to Embodiment 1 of the present invention;

FIG. 4 is a schematic front view of a visual intelligent screening system according to Embodiment 2 of the present invention; and

FIG. 5 is a schematic diagram of a first sorting apparatus, a second sorting apparatus, or a third sorting apparatus according to Embodiment 2 of the present invention.

In the drawings: 1, material receiving and conveying mechanism; 2, first slide-down board; 3, first conveying mechanism; 4, second slide-down board; 5, second conveying mechanism; 6, third slide-down board; 7, third conveying mechanism; 8, support board; 9, angle adjustment cylinder; 10, hydraulic cylinder; 11, first traveling vehicle; 12, second traveling vehicle; 13, hydraulic cylinder; 14, baffle board; 15, fourth conveying mechanism; 16, first 3D laser contour sensor; 17, blowing pump; 18, rotation drive motor; 19, screening slide-down board; 20, second 3D laser contour sensor; 21, first sorting apparatus; 22, first color mark sensor group; 23, second sorting apparatus; 24, second color mark sensor group; 25, third sorting apparatus; 26, vacuum chuck; 27, angle adjustment motor; 28, counting sensor; 29, control system; and, 30, industrial computer.

### DETAILED DESCRIPTION

### Example 1

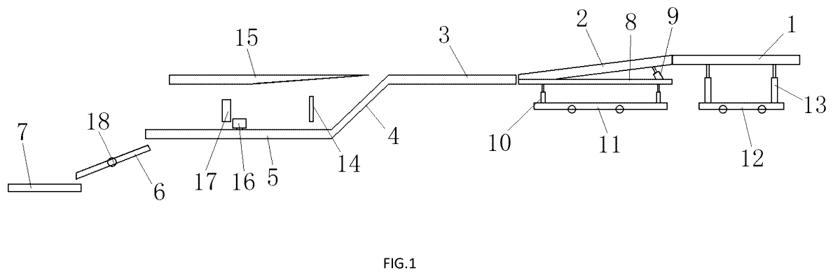

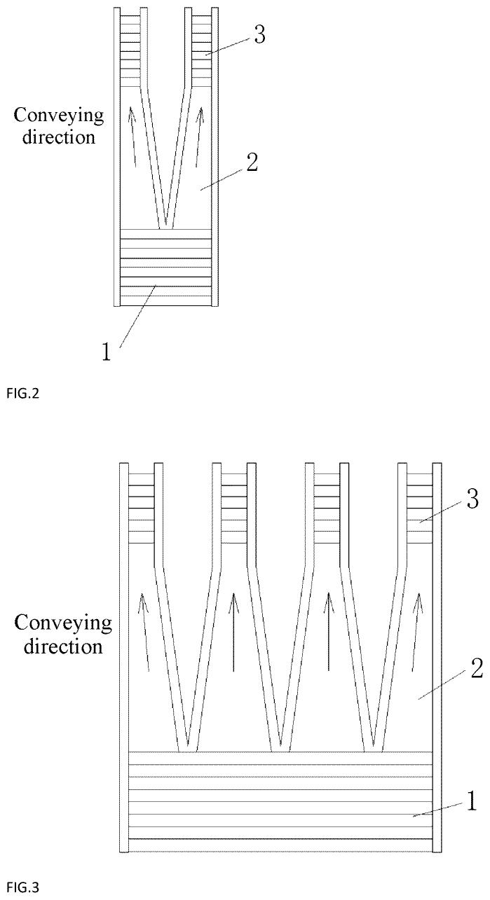

The present example provides an automatic loading system for screening wood shavings. As shown in FIG. 1 to FIG. 3, the automatic loading system includes a material receiving and conveying mechanism 1. The material receiving and conveying mechanism 1 is configured to receive to-be-detected wood shavings. The wood shavings received by the material receiving and conveying mechanism 1 are a large quantity of wood shavings piled up disorderedly.

In the present example, a belt conveying mechanism is used as the material receiving and conveying mechanism 1, and can convey the wood shavings.

A tail end of the material receiving and conveying mechanism 1 is connected to a feeding end of a plurality of shaving arranging and conveying mechanisms, and the plurality of received wood shavings can be fed into the plurality of shaving arranging and conveying mechanisms. The plurality of the shaving arranging and conveying mechanisms may be two, four, or more. A person skilled in the art sets the number of shaving arranging and conveying mechanisms according to an actual requirement, and details are not described herein.

The shaving arranging and conveying mechanism includes a first slide-down board 2, a first conveying mechanism 3, a second slide-down board 4, a second conveying mechanism 5, a third slide-down board 6, and a third conveying mechanism 7 sequentially disposed along a conveying direction of wood shavings.

The first slide-down board 2 is configured to receive the wood shavings conveyed by the material receiving and conveying mechanism 1, and enable the wood shavings to slide down to the first conveying mechanism 3 under gravity.

In the present example, the first slide-down board 2 has a feeding end with a height greater than a height of a discharging end to enable wood shavings to slide down, and includes a bottom board, and material blocking boards are disposed on two sides of the bottom board. Material blocking boards close to each other of adjacent first slide-down boards 2 are crossed and fixed in the shape of V at the feeding end, to shunt wood shavings, so that wood shavings on the material receiving and conveying mechanism 1 enter different first slide-down boards 2.

In the present example, a width of the first slide-down board 2 is gradually reduced along the conveying direction of the wood shavings, and the first slide-down board 2 has a width at a discharging end that corresponds to a width of the wood shavings and that is slightly greater than the width of the wood shavings, to enable the wood shavings to pass through a discharging end of the first slide-down board only in a posture having a length direction that is set along the conveying direction, to direct the wood shavings.

A single wood shaving or a plurality of stacked-up wood shavings passes through the first slide-down board 2, where a length direction of the single wood shaving is set along the conveying direction, and a length direction of the stacked-up wood shavings is set along the conveying direction.

Further, to prevent the wood shavings from blocking the first slide-down board 2 in the slide-down process, a vibration motor is mounted on a bottom surface of the first slide-down board 2, and the vibration motor vibrates the first slide-down board 2, to ensure smooth slide-down of the wood shavings.

Further, to satisfy slide-down requirements for different wood shavings, the angle of the first slide-down board 2 can be adjusted. Specifically, the discharging end of the first slide-down board 2 is rotatably connected to a support board 8, another end of the first slide-down board 2 is hinged to an end of an angle adjustment cylinder 9, another end of the angle adjustment cylinder 9 is hinged to the support board 8, and expansion and contraction of a piston rod of the angle adjustment cylinder 9 can drive the first slide-down board 2 to rotate, thereby adjusting the angle of the first slide-down board 2.

Further, to enable the first slide-down board 2 to be docked to the material receiving and conveying mechanism and the first conveying mechanism at any angle, and ensure smooth conveying of wood shavings, the support board 8 is connected to a second lifting mechanism. In the present example, hydraulic cylinders 10 disposed at a front end and a rear end of the support board is used as the second lifting mechanism, a piston rod of the hydraulic cylinder 10 is connected to the support board 8, a cylinder body of the hydraulic cylinder 10 is fixed to a first traveling vehicle 11, and an existing electric traveling vehicle is used as the first traveling vehicle 11, whose specific structure is not described in detail herein. Correspondingly, the material receiving and conveying mechanism 1 is mounted on a second traveling vehicle through a third lifting mechanism. In the present example, a hydraulic cylinder 13 mounted on the second traveling vehicle 12 is used as the third lifting mechanism, the hydraulic cylinder has a cylinder body connected to the second traveling vehicle and a piston rod connected to the material receiving and conveying mechanism, and an existing electric traveling vehicle is used as the second traveling vehicle 12, whose specific structure is not described in detail herein.

In the present example, after the angle of the first slide-down board 2 is adjusted, the second lifting mechanism and the first traveling vehicle 11 collaboratively work preferentially, to dock the discharging end of the first slide-down board 2 to the feeding end of the first conveying mechanism 3, and then the second traveling vehicle 12 and the third lifting mechanism work, to dock the material receiving and conveying mechanism 1 to the feeding end of the first slide-down board 2.

It should be noted that, because wood shavings are lightweight, the vibration motor slightly vibrates the first slide-down board 2, which can ensure that the wood shavings do not cause blocking, and the vibration of the first slide-down board does not affect normal work of the angle adjustment cylinder 9, the hydraulic cylinder 10, and the first traveling vehicle 11.

In another implementation, an outside middle position of the first slide-down board 2 is connected to an output shaft of a rotation drive motor, the rotation drive motor is fixed to the support board 8 through a motor base, and the support board is connected to the second lifting mechanism.

A belt conveying mechanism is used as the first conveying mechanism 3, has a width matching the width of the wood shavings, and is configured to receive the wood shavings discharged by the first slide-down board 2 and further convey the wood shavings.

The feeding end of the first conveying mechanism 3 is connected to the feeding end of the second slide-down board 4, the height of the feeding end of the second slide-down board 4 is greater than the height of the discharging end, and the angle of the second slide-down board 4 is set to a large angle to enable any wood shaving to slide down under gravity. The width of the second slide-down board 4 matches the width of the wood shavings, and material blocking boards are disposed on two sides of the second slide-down board to prevent the wood shavings from falling off from the second slide-down board 4.

The discharging end of the second slide-down board 4 is connected to the feeding end of the second conveying mechanism 5 to receive wood shavings discharged by the second slide-down board 4.

In the present example, a belt conveying mechanism is used as the second conveying mechanism 5, and has a width matching the width of the wood shavings.

A baffle board 14 is disposed above the feeding end of the second conveying mechanism 5, there is a set gap between a bottom end of the baffle board 14 and a top surface of the second conveying mechanism 5, and the set gap allows only a single wood shaving to pass through, to spread the stacked-up wood shavings.

Further, the baffle board 14 is connected to the first lifting mechanism, and the first lifting mechanism can lift the baffle board 14, to adjust the size of the set gap.

In the present example, lead screw lifting mechanisms located on two sides of the second conveying mechanism 5 are used as the first lifting mechanism, a lead screw lifting mechanism in the existing technology is used, and lifting parts of the lead screw lifting mechanisms on the two sides are connected to two ends of the baffle board 14 respectively to drive the baffle board to be lifted.

A fourth conveying mechanism 15 is disposed at a third set distance in front of a junction position between the discharging end of the first conveying mechanism 3 and the feeding end of the second slide-down board 4. A belt conveying mechanism is used as the fourth conveying mechanism 15. A top surface of the fourth conveying mechanism 15 is higher than a top surface of the first conveying mechanism 3 by a fourth set distance, to facilitate falling of the wood shavings. The stacked-up wood shavings are capable of being initially spread when passing through a gap between a feeding end of the fourth conveying mechanism 15 and a discharging end of the first conveying mechanism 3, wood shavings located above enter the fourth conveying mechanism 15, and wood shavings located below fall along the second slide-down board 4.

The third set distance and the fourth set distance may be set according to an actual requirement, and are not described in detail herein.

In the present example, a belt conveying mechanism is used as the fourth conveying mechanism 15, whose discharging end is connected to the material receiving and conveying mechanism 1, to transfer wood shavings to the material receiving and conveying mechanism 1.
a first 3D laser contour sensor 16 and a blowing pump 17 are disposed on a side of the second conveying mechanism 5 downstream of the baffle board 14 along the conveying direction of wood shavings, and the first 3D laser contour sensor 16 is located upstream of the blowing pump 17. The first 3D laser contour sensor 16 is configured to detect wood shavings passing through the gap between the baffle board 14 and the second conveying mechanism 5. When there are still stacked-up wood shavings, after the stacked-up wood shavings are moved to a position corresponding to the blowing pump 17, the blowing pump 17 works to blow off the stacked-up wood shavings.

An existing device may be used as the first 3D laser contour sensor 16, has a laser emitting end and a laser receiving end, and can scan a side of wood shavings, thereby recognizing wood shavings in a stacked-up state.

The blowing pump 17 is located on a side of the second conveying mechanism 5, a fifth conveying mechanism is located on another side of the second conveying mechanism 5, the fifth conveying mechanism is disposed opposite to the blowing pump 17, and wood shavings blown off by the blowing pump 17 can fall onto the fifth conveying mechanism.

In the present example, a belt conveying mechanism is used as the fifth conveying mechanism, and a discharging end of the fifth conveying mechanism is connected to the material receiving and conveying mechanism 1, to transfer wood shavings transferred by the fifth conveying mechanism to the material receiving and conveying mechanism 1.

The width of the third slide-down board 6 matches the width of the wood shavings, and shaving blocking boards are disposed on two sides of the third slide-down board 6 to prevent the wood shavings from falling off from the third slide-down board 6.

The third slide-down board 6 has a feeding end located below a discharging end of the second conveying mechanism 5 at a first set distance, and a discharging end located above a feeding end of the third conveying mechanism 7 at a second set distance.

Through such a disposition manner, when entering the third slide-down board 6 from the second conveying mechanism 5, wood shavings enter at intervals of a set time instead of continuously entering, so that adjacent wood shavings are spaced apart by a specific gap.

The first set distance and the second set distance may be set according to an actual requirement, and are not described in detail herein.

Further, a middle position on each of two sides of the third slide-down board 6 is connected to a rotation drive member, a rotation drive motor 18 is used as the rotation drive member, the rotation drive motor 18 is fixed to a bracket through a motor base, and the bracket is fixed to a ground foundation. Through rotation drive motor 18, the angle of the third slide-down board 6 can be adjusted, thereby satisfying a slide-down transfer requirement for various wood shavings.

In the present example, relative positions of the second conveying mechanism 5 and the feeding end of the third slide-down board 6 need to satisfy a condition that the wood shavings can fall onto the third slide-down board 6 from the second conveying mechanism 5 when the third slide-down board 6 is adjusted to any angle, and relative positions of the discharging end of the third slide-down board 6 and the feeding end of the third conveying mechanism 7 need to satisfy a condition that the wood shavings can fall onto the third conveying mechanism 7 from the third slide-down board 6 when the third slide-down board 6 is adjusted to any angle.

A belt conveying mechanism is used as the third conveying mechanism 7, and has a width matching the width of the wood shavings. A conveying speed of the third conveying mechanism is greater than a conveying speed of the second conveying mechanism 5, to transfer the wood shavings to a visual intelligent screening system.

A working method of the loading system of the present example is as follows:

Driven by the material receiving and conveying mechanism 1, a plurality of wood shavings separately enters different first slide-down boards 2, and slides down on the first slide-down boards 2. In the slide-down process, the width of the first slide-down board 2 is gradually reduced, and the width of the discharging end of the first slide-down board matches the width of the wood shavings. Therefore, after the wood shavings are discharged from the first slide-down board 2, the length direction of the wood shavings is set along the conveying direction, to adjust the orientation of the wood shavings, thereby directionally arranging the wood shavings. Then, the wood shavings enter the first conveying mechanism 3 and are further conveyed, the first conveying mechanism 3 conveys the wood shavings to the second slide-down board 4, and the wood shavings slide down and are transferred along the second slide-down board 4.

When wood shavings pass through the gap between the discharging end of the first conveying mechanism 3 and the feeding end of the fourth conveying mechanism 15, stacked-up wood shavings are initially spread. Among the stacked-up wood shavings, an upper wood shaving enters the fourth conveying mechanism 15, passes through the fourth conveying mechanism 15, and enters the material receiving and conveying mechanism 1 again, and a lower wood shaving enters the second slide-down board 4 and slides down.

When wood shavings pass through the second slide-down board 4 and then enter the second conveying mechanism 5, and then wood shavings pass through the gap between the baffle board 14 and the second conveying mechanism 5, stacked-up wood shavings are further spread. When the wood shavings pass through the first 3D laser contour sensor 16, the first 3D laser contour sensor 16 detects whether a lamination phenomenon still exists for the wood shavings. When stacked-up wood shavings are detected, a signal is sent to a control system, the control system controls the blowing pump 17 to work. When the stacked-up wood shavings move to a position corresponding to the blowing pump 17, the blowing pump 17 works, to blow the stacked-up wood shavings to the fifth conveying mechanism, and the fifth conveying mechanism conveys the wood shavings to the material receiving and conveying mechanism 1 again.

The second conveying mechanism 5 transfers the wood shavings, and the wood shavings fall off to the third slide-down board 6 from the discharging end of the second conveying mechanism 5. Because the feeding end of the third slide-down board 6 is located below the discharging end of the second conveying mechanism 5 at a first set distance, the wood shavings do not enter the third slide-down board 6 continuously, but enter at intervals of a specific distance, to transfer two adjacent wood shavings at intervals of a specific distance.

The wood shavings discharged by the third slide-down board 6 enter the third conveying mechanism 7, and the third conveying mechanism 7 feeds the wood shavings into the visual intelligent screening system.

According to the automatic loading system for screening wood shavings in the present example, a plurality of wood shavings is arranged and conveyed sequentially at intervals of the particular distance, a requirement of performing detection and screening by using the visual intelligent screening system is satisfied, working efficiency and quality of detecting and screening wood shavings are improved, and labor intensity of working personnel is reduced.

### Example 2

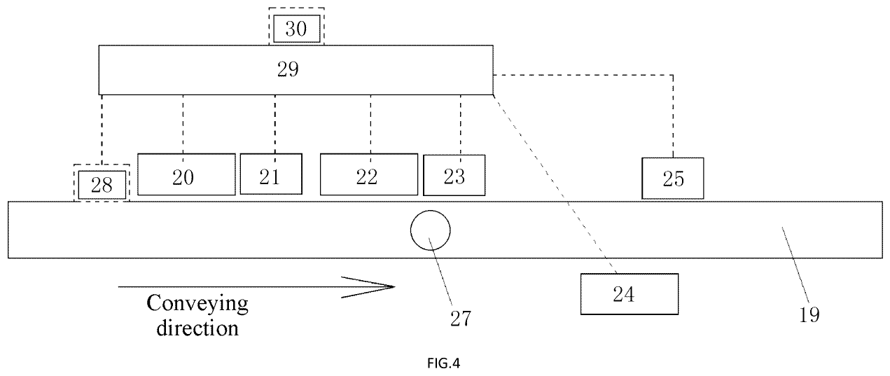

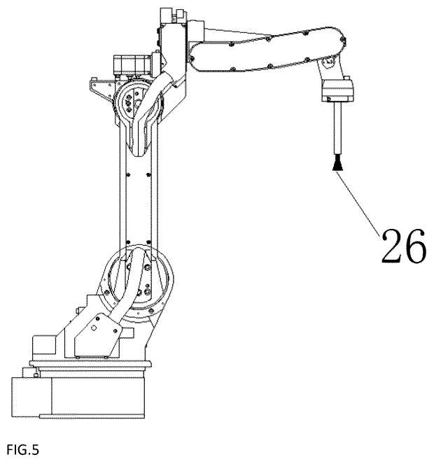

The present example provides an intelligent screening line for wood shavings, including the automatic loading system for screening wood shavings according to Embodiment 1, and further including a visual intelligent screening system. As shown in FIG. 4, the visual intelligent screening system includes a screening slide-down board 19, a width of the screening slide-down board 19 matches a width of wood shavings and is slightly greater than the width of the wood shavings, limiting boards are disposed on two sides to prevent the wood shavings from falling off from the screening slide-down board 19 in a slide-down process, a height of a feeding end of the screening slide-down board 19 is greater than a height of a discharging end, and the feeding end of the screening slide-down board 19 is located below the discharging end of the third conveying mechanism 7 at a set distance to be capable of receiving a wood shaving discharged from the third conveying mechanism 7.

A transparent board, preferably, a transparent glass board is used as the screening slide-down board 19. A second 3D laser contour sensor 20, a first sorting apparatus 21, a first color mark sensor group 22, a second sorting apparatus 23, a second color mark sensor group 24, and a third sorting apparatus 25 are sequentially disposed along a slide-down direction of the wood shavings on the screening slide-down board 19.

The second 3D laser contour sensor 20 and the first color mark sensor group 22 are located above the screening slide-down board 19, and the second color mark sensor group 24 is located below the screening slide-down board 19.

Because a detection range of a single color mark sensor cannot cover an entire wood shaving surface, the first color mark sensor group 22 and the second color mark sensor group 24 are each provided with a plurality of color mark sensors, so that a coverage range of the plurality of color mark sensors covers a width direction of the entire wood shaving surface.

As shown in FIG. 5, a robotic arm, preferably, an existing six-degree-of-freedom robotic arm is used as each of the first sorting apparatus 21, the second sorting apparatus 23, and the third sorting apparatus 25, whose specific structure is not described in detail herein. A tail end of the six-degree-of-freedom robotic arm is connected to a vacuum chuck 26, which can adsorb, fix, and release a wood shaving.

In the present example, the second 3D laser contour sensor 20, the first color mark sensor group 22, and the second color mark sensor group 24 are each mounted on a corresponding sensor bracket, and each of the plurality of sensor brackets is fixedly connected to the screening slide-down board 19.

Further, to satisfy a requirement of adjusting distances between the second 3D laser contour sensor 20, the first color mark sensor group 22, the second color mark sensor group 24, and the screening slide-down board 19, the second 3D laser contour sensor 20 is mounted on a sensor bracket through one fourth lifting mechanism, the first color mark sensor group 22 is mounted on a sensor bracket through one fourth lifting mechanism, and the second color mark sensor group 24 is mounted on a sensor bracket through one fourth lifting mechanism.

In the present example, an existing lead screw lifting mechanism is used as the fourth lifting mechanism, whose specific structure is not described in detail herein.

Three six-degree-of-freedom robotic arms are fixed to a robotic arm mounting base, and the robotic arm mounting base is fixed to the screening slide-down board 19.

Further, to satisfy a slide-down requirement of different wood shavings on the screening slide-down board, a middle position on a side of the screening slide-down board 19 is connected to an angle adjustment mechanism, an angle adjustment motor 27 is used as the angle adjustment mechanism, the angle adjustment motor 27 is fixed to a motor base, and the motor base is fixed to the ground foundation.

Further, along the conveying direction of wood shavings, a counting sensor 28 is disposed upstream of the second 3D laser contour sensor 20. In the present example, a photoelectric sensor or a laser ranging sensor is used as the counting sensor 28, which is set by a person skilled in the art according to an actual requirement. The counting sensor 28 is disposed above the screening slide-down board 19, and is mounted on a sensor bracket, and the sensor bracket is fixedly connected to the screening slide-down board 19.

The counting sensor 28, the second 3D laser contour sensor 20, the first color mark sensor group 22, the second color mark sensor group 24, and the three sorting apparatuses are each connected to a control system 29, the control system 29 is connected to an industrial computer 30, the counting sensor 28, the second 3D laser contour sensor 20, the first color mark sensor group 22, and the second color mark sensor group 24 can transmit detected information to the control system 29, and the control system 29 controls the three sorting apparatuses to work, to screen the wood shavings.

According to the intelligent screening line for wood shavings in the present example, when the wood shavings slide down on the screening slide-down board 19, and pass through the second 3D laser contour sensor 20, cracks on the wood shavings are detected. After the detection is completed, the wood shavings continue to slide down. The control system makes a judgment through a detection result of the second 3D laser contour sensor 20, and qualified wood shavings continue to slide down. When an unqualified product is encountered, the first sorting apparatus 21 is controlled to work, and the first sorting apparatus 21 grips and rejects the unqualified product by using the vacuum chuck 26.

In the present example, after performing laser scanning on a wood shaving, the second 3D laser contour sensor may identify a width and a length of a crack inside the wood shaving, and further obtain an area of the crack. In addition, the second 3D laser contour sensor can also identify a length and a width of the entire wood shaving, and calculate an area of the entire wood shaving. A value may be obtained by dividing the area of the crack by the area of the entire wood shaving. When the value exceeds a set limit value, it is determined that the wood shaving is unqualified; otherwise, the wood shaving is qualified. The set limit value may be determined according to an actual production situation, and is not described in detail herein.

Specifically, the second 3D laser contour sensor emits line laser. After the line laser is emitted from an emitting port, the line laser is bounced back on an object to a receiving port, and the line laser can identify elevation information of the object, and therefore can identify the width of the crack and the width of the wood shaving. A suitable sampling frequency is set for the second 3D laser contour sensor. Widths of a plurality of cracks and the width of the wood shaving may be obtained as the wood shaving moves on the screening slide-down board. By using information about the cracks, two-dimensional grid matrix data of the cracks may be generated, and then a length and a width of each crack of the wood shaving are obtained.

Similarly, the length and the width of the entire wood shaving can also be obtained. An area of the cracks of the wood shaving may be obtained according to the length information and the width information of the cracks. Similarly, an area of the entire wood shaving may also be obtained. A value may be obtained by dividing the area of the cracks by the area of the wood shaving, and whether the wood shaving is a qualified product may be determined by using the value.

The wood shavings continue to slide down and passes through the first color mark sensor group 22, the first color mark sensor group 22 detects a color of an upper surface of the wood shaving, and a qualified product continues to slide down. When an unqualified product is encountered, the control system 29 controls the second sorting apparatus 23 to work, to grip an unqualified product and then reject the unqualified product. When the wood shavings slide down to the second color mark sensor group 24, the second color mark sensor group 24 detects a color of a lower surface of the wood shaving, a qualified product continues to slide down, and an unqualified product is gripped and rejected by the third sorting apparatus 25.

In the present example, changes in temperature and humidity cause significant blue stains and molds locally on the wood shaving. The color mark sensor may determine an area of a blue stain part and an area of a mold part of a wood shaving and the area of the entire wood shaving. A value may be obtained by dividing a sum of the area of the blue stain part and the area of the mold part by the area of the entire wood shaving. When the value exceeds a set limit value, it is determined that the wood shaving is unqualified. The set limit value may be determined according to an actual production operating condition, and is not described in detail herein.

The color mark sensor may identify a color of a detected object. A single detection range of the color mark sensor is far less than that of the wood shaving, and a suitable sampling frequency is set for the color mark sensor. As the wood shavings move on the screening slide-down board, the color mark sensor may first clearly identify a detection start point of a to-be-detected wood shaving, and therefore a plurality of color mark detection results is obtained. As the detection is performed, the color mark sensor may also identify a detection end point of the to-be-detected wood shaving. Because a detection width of a color mark sensor is very limited, final detection of the wood shaving can be completed only by using a plurality of color mark sensors. A detection range of a plurality of color mark sensors covers a width of an entire wood shaving. According to a plurality of pieces of color mark detection information obtained in a detection process, a blue stain area and a mold area of the wood shaving and an area of the entire wood shaving may be obtained. A value may be obtained by dividing a sum of the blue stain area and the mold area by the area of the entire wood shaving. When the value exceeds a set limit value, and whether the wood shaving is a qualified product may be determined by using the value.

In some other embodiments, an industrial camera may alternatively be used to replace the color mark sensor. The industrial camera collects an image of a wood shaving, identifies a blue stain part and a mold part by using the image, obtains a ratio of a sum of an area of the blue stain part and an area of the mold part to an area of the entire wood shaving, and determines whether the wood shaving is a qualified product according to the ratio. An existing technology is used as the foregoing technology, and is not further described in detail herein.

In the present example, detection performed on the wood shavings by using the visual intelligent screening system improves working efficiency, reduces labor intensity, and improves screening accuracy compared with manual detection. In addition, working personnel does not need to perform manual detection beside a production line, thereby ensuring labor safety of the working personnel.

The foregoing descriptions are merely preferred embodiments of this application, and are not intended to limit this application. For a person skilled in the art, this application may have various modifications and variations. Any modification, equivalent replacement, improvement, and the like made within the spirit and principle of this application shall fall within the protection scope of this application.

1. An automatic loading system for screening wood shavings, comprising a material receiving and conveying mechanism, wherein a discharging side of the material receiving and conveying mechanism is connected to a feeding side of a plurality of shaving arranging and conveying mechanisms, each of the plurality of the shaving arranging and conveying mechanisms comprises a first slide-down board, a first conveying mechanism, a second slide-down board, a second conveying mechanism, a third slide-down board, and a third conveying mechanism sequentially disposed along a conveying direction of wood shavings, a width of the first slide-down board is gradually reduced along the conveying direction of the wood shavings to cause the width of the first slide-down board on a discharging side of the first slide-down board to correspond to a width of the wood shavings, the first slide-down board comprises a bottom board and material blocking boards disposed on two sides of the bottom board, and the first slide-down board is connected to a vibration motor, to enable the wood shavings to pass through a discharging end of the first slide-down board only in a posture having a length direction that is set along the conveying direction, to direct the wood shavings; and a baffle board is disposed above a feeding end of the second conveying mechanism, a set gap exists between a bottom end of the baffle board and a top surface of the second conveying mechanism to allow only a single wood shaving to pass through the gap between the baffle board and the second conveying mechanism, and the third slide-down board has a feeding end located below a discharging end of the second conveying mechanism at a first set distance, and a discharging end of the third slide-down board is located above a feeding end of the third conveying mechanism at a second set distance;
a fourth conveying mechanism is disposed in front of the first conveying mechanism at a third set distance, and a top surface of the fourth conveying mechanism is higher than a top surface of the first conveying mechanism by a fourth set distance to initially spread the stacked-up wood shavings; and the stacked-up wood shavings are capable of being initially spread when passing through a gap between a feeding end of the fourth conveying mechanism and a discharging end of the first conveying mechanism, wood shavings located above enter the fourth conveying mechanism, and wood shavings located below fall along the second slide-down board; and
a tail end of the fourth conveying mechanism is connected to the material receiving and conveying mechanism.

2. The automatic loading system for screening wood shavings according to claim 1, wherein a first three-dimensional (3D) laser contour sensor and a blowing pump are sequentially disposed on a side of the second conveying mechanism downstream of the baffle board along the conveying direction of wood shavings, and the first 3D laser contour sensor is configured to detect the stacked-up wood shavings to blow the stacked-up wood shavings off through the blowing pump.

3. The automatic loading system for screening wood shavings according to claim 2, wherein a fifth conveying mechanism is disposed on an opposite side of the blowing pump to receive the wood shavings blown off by the blowing pump, and a tail end of the fifth conveying mechanism is connected to the material receiving and conveying mechanism.

4. The automatic loading system for screening wood shavings according to claim 1, wherein the baffle board is connected to a first lifting mechanism to adjust a distance between the bottom end of the baffle board and the second conveying mechanism.

5. The automatic loading system for screening wood shavings according to claim 1, wherein the discharging end of the first slide-down board is hinged to a support board, another end of the first slide-down board is hinged to an end of an angle adjustment cylinder, another end of the angle adjustment cylinder is hinged to the support board, the support board is mounted on a first traveling vehicle through a second lifting mechanism, and correspondingly, the material receiving and conveying mechanism is mounted on a second traveling vehicle through a third lifting mechanism.

6. The automatic loading system for screening wood shavings according to claim 1, wherein a center position of the third slide-down board is connected to a rotation drive element to adjust an angle of the third slide-down board.

7. An intelligent screening line for wood shavings, comprising the automatic loading system for screening wood shavings according to any one of claims 1 to 6, and further comprising a visual intelligent screening system, wherein a discharging end of the third conveying mechanism corresponds to a feeding end of the visual intelligent screening system, and the visual intelligent screening system comprises a screening slide-down board, a transparent board is used as the screening slide-down board, and a second 3D laser contour sensor, a first sorting apparatus, a first color mark sensor group, a second sorting apparatus, a second color mark sensor group, and a third sorting apparatus are sequentially disposed along the conveying direction of the wood shavings, wherein the 3D laser contour sensor and the first color mark sensor group are located above the screening slide-down board, and the second color mark sensor group is located below the screening slide-down board.

8. The intelligent screening line for wood shavings according to claim 7, wherein the screening slide-down board is connected to an angle adjustment mechanism, and the second 3D laser contour sensor, the first sorting apparatus, the first color mark sensor group, the second sorting apparatus, the second color mark sensor group, and the third sorting apparatus are each connected to the screening slide-down board through a bracket.

9. The intelligent screening line for wood shavings according to claim 8, wherein the second 3D laser contour sensor, the first color mark sensor group, and the second color mark sensor group are each connected to a bracket through a fourth lifting mechanism.

10. The intelligent screening line for wood shavings according to claim 7, wherein robotic arms are used as the first sorting apparatus and the second sorting apparatus, and a vacuum chuck is disposed at a tail end of the robotic arm.
